(19) United States
(12) Patent Application Publication
(10) Pub. No.: US 2019/0248051 A1
(43) Pub. Date: Aug. 15, 2019

(54) PROCESS FOR MANUFACTURING A METAL CONTAINER HAVING A PLASTIC EXTERIOR SUSCEPTABLE TO RECEIVING INDICIA USING DYE SUBLIMATION

(71) Applicant: Sun-Fly International Business Development Limited, Guangzhou (CN)

(72) Inventor: Xuhui Sun, Guangzhou (CN)

(73) Assignee: Sun-Fly International Business Development Limited, Guangzhou (CN)

(21) Appl. No.: 15/893,760

(22) Filed: Feb. 12, 2018

(51) Int. Cl. B29C 45/14; B29C 45/00; B29C 45/73; A47G 19/22

(52) U.S. Cl. CPC B29C 45/14336; B29C 45/0053; B29L 2031/7132; B29C 45/0001; A47G 19/2205; B29C 45/73

(57) ABSTRACT

A process is disclosed to encapsulate the exterior surface of a metal drinking cup or other similar heat resistant container with plastic material such as polybutylene terephthalate in an injection molding process. A fixture holds a metal container in place and is inserted within a mold. Plastic material is then injected into the mold and surrounds the exterior surface of the container and allowed to cool. The container includes various physical features on its exterior to prevent the slipping of the plastic material off of the cup after cooling. Using an injection molding process to surround and encapsulate the exterior surface of a metal container with plastic results in a thicker surface over the container, and creates an ideal platform for receiving high resolution images and designs for impregnation using a further dye sublimation process.

### FIELD OF THE INVENTION

The present invention relates generally to injection molding processes. In greater particularity, the present invention relates to coating metal containers with plastic using injection molding. In even greater particularity, the present invention relates to manufacturing processes for creating a plastic coated metal cup susceptible to receiving indicia with dye sublimation.

### BACKGROUND OF THE INVENTION

Dye sublimation is used on many articles of manufacturer in order to apply high resolution images, such as photo grade images, to various consumer articles or customize those articles for consumer use. Coffee mugs and travel mugs, such as sold at automobile travel centers and tourist gift shops, have become a popular item for consumers, and dye sublimation is utilized frequently to enhance the exterior of these articles using high volume manufacturing operations to reduce costs. Solid plastic containers such as made by injection molding processes are suitable for the addition of dye sublimation images on their exteriors. Unfortunately, higher quality materials such as metal or ceramic materials like glass based ceramics with glass coatings or glass exteriors do not typically accept images using dye sublimation, thereby requiring the application of an external coating to these articles, such as polyester. Such pre-coatings are typically sprayed on or applied through dipping and oven fixed onto the exterior, thereby increasing the expense of dye sublimating these articles. Further, metal coffee cups and travel tumblers, such as stainless steel and aluminum alloy based tumblers, do not offer sufficient visual reflectivity to project a dye sublimation image, resulting in an unattractive dull or subdued image on a metal exterior unless a background color is added first onto the exterior material. In a high volume manufacturing operation, such increased costs can be amortized for a single image setup over a larger volume, but these additional steps may make low volume operations such as local kiosk or gift shop operations financially impractical.

Consequently, these common materials have not been able to enjoy the low cost manufacturability of low volume variability of designs and indicia on their exteriors using dye sublimation, nor have they been able to fully enjoy the secondary market of personalization and customization offered at booth or kiosk operations, such as present in theme parks or tourist locations.

Some manufacturers have attempted to use dipping processes to cover the exterior of coffee mugs or metal travel mugs, such as with polyvinyl alcohol hydrographic films, but such dipping techniques only leave a thin coating of material on the exterior such that a dye sublimation image cannot penetrate into the deeper layers of the coated exterior, leaving the image susceptible to wearing off. Further, the types of exteriors left with such dipping processes, are not as receptive a medium for receiving dye sublimation images as with plastic, such as the plastics used in injection molding operations.

Also, another drawback of using dipping or spraying on material on the exterior of the above noted articles is that the resulting exteriors are not attractive to consumers because it does not promote an impression of high quality or durability to the potential customer, nor do they provide a sufficiently insulating layer for holding metal tumblers or travel mugs. For example, the typical material used in dipping is of a light weight type and does not typically protect ceramic mugs or a travel containers from damage if dropped or if impacted against other objects, nor does such a light weight article promote an impression of product excellence for a consumer. Thermal isolation for the container is also not achieved.

Therefore, what is needed is a manufacturing process that allows for the economical utilization of dye-sublimation applied to low volume, high resolution marking on the exterior of various types of containers, such as coffee mugs and travel mugs, while providing a consumer enhancing attractiveness.

### SUMMARY OF THE INVENTION

The present invention is a process for encapsulating the exterior of a metal drinking cup or other similar metal container with plastic materials such as polybutylene terephthalate or “PBT” in an injection molding process. A fixture holds a metal container such as a travel mug or tumbler on its exterior and inserts the container within a mold and sealing it against the mold. PBT material is injected into the mold to surround the exterior surface of the container being held by the fixture and the combination of plastic and container is allowed to cool. The cup has various physical features on its exterior to prevent the slipping of the PBT material off of the cup due to handling or shrinkage of the plastic material. Because of the usage of an injection molding process to surround and encapsulate the exterior surface of a metal container results in a thicker surface over the container, the created exterior sleeve is an ideal platform for receiving designs for impregnation within the PBT surface via dye sublimation. Additives may be combined with the PBT to enhance its attractiveness and to increase the visual characteristics of any design or indicia that may be subsequently added to the exterior of the PBT material through dye sublimation.

Other features and objects and advantages of the present invention will become apparent from a reading of the following description as well as a study of the appended drawings.

### BRIEF DESCRIPTION OF THE DRAWINGS

FIG. 1 a simplified view of a metal cup positioned over a metal fixture and being positioned for mating with a plastic injection mold for injection of PBT to surround the exterior of the metal cup;

FIG. 2 is a diagram of a typical metal cup surrounded by a PBT sleeve;

FIG. 3A is an embodiment of a metal cup showing one aspect of a retaining strategy for gripping the PBT;

FIG. 3B is a second embodiment of a metal cup showing another aspect of a retaining strategy for gripping the PBT;

FIG. 3C is a third embodiment of a metal cup showing another aspect of a retaining strategy for gripping the PBT;

FIG. 4 is a flow diagram of the manufacturing process; and,

FIG. 5 is a flow diagram showing a process of dye sublimation transferring an image onto the sleeve of the container.

### DESCRIPTION OF THE PREFERRED EMBODIMENTS

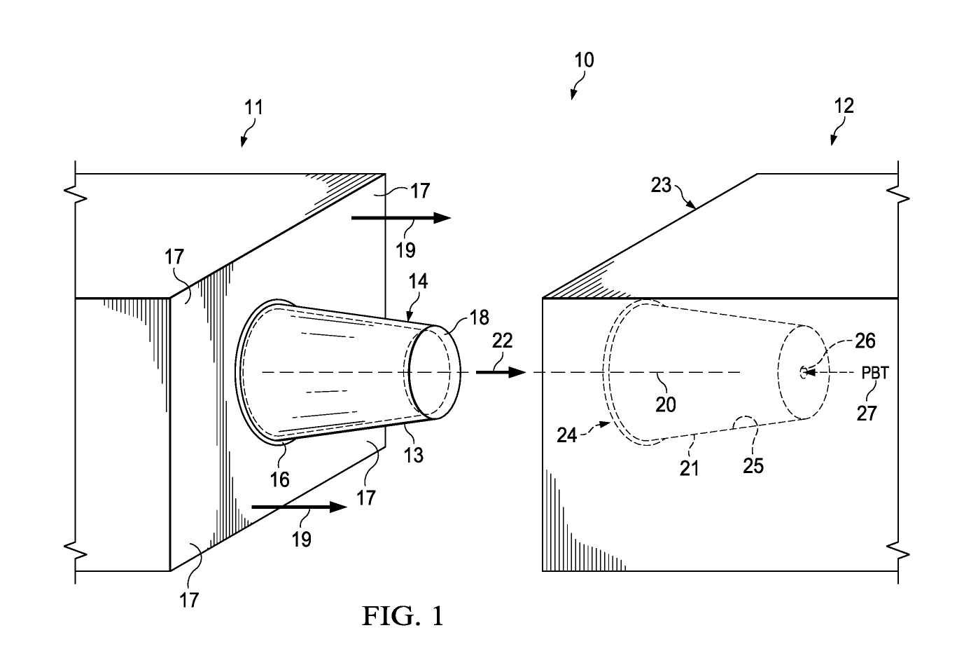

Referring to the drawings for a better understanding of the function and structure of the invention, FIG. 1 shows an injection molding system 10 having a static section 12 and a moving section 11. Moving section 11 includes a fixture 13 affixed to face 17 having a shape generally matching the shape of a container 14. Section 11 moves in direction 19 toward static section 12. Fixture 13 is generally oriented orthogonally with respect to face 17 and extending away from it as shown. Fixture 13 also includes a distal end 18 having a central axis 20 oriented in a direction for mating with a mold 21 spaced from and held within a static side 12 of machine 10.

Except for limitations pertaining to the herein described process, the general process of plastic extrusion or the workings of a plastic extrusion machine are not included in as much as such general details are well understood and not necessary for a complete understanding of the herein described invention. A satisfactory extrusion machine for practicing the herein described process is the Pluto series model number PL1200/370j offered by Ningbo Haitian Tianjian Machinery Co., Ltd.

A container, such as a drinking cup or travel mug made from stainless steel or other heat resistant material 14 is positioned over fixture 13 in close conformity thereof such that the bottom of the container 14 bears against the fixture distal end 18 when positioned over fixture 13. As may be understood, fixture 13 is sized and shaped to generally support the inner surface of container 14 during the herein described extrusion process. Further, either container 14 or fixture 13 includes a circumferential flange 16 that is positioned in flush orientation against outer face 17 in order to capture and retain the flow of extruded plastic material within a mold 21 during the extrusion step.

A stationary side 12 of machine 10 includes a face 23 oriented in parallel relation to face 17 such that when section 11 moves toward section 12 faces 17 and 23 will mate in flush relation. As may be seen, section 11 when moved toward section 12 urges fixture 13 holding cup 14 toward section 12 and into mold 21 thereby filling cavity 24, and are drawn together in direction 22 along axis 20. As sections 11 and 12 draw together, cup 14 is encapsulated within mold 21 but the diameter of mold 21 is sized larger than the diameter of cup 13 such that the outer surface of said cup 13 is spaced from the inner surface of mold 21 by a predetermined distance, typically 0.8 mm to 2.0 mm. Once face 17 is seated against face 23, flange 16 is presses against face 17 and simultaneously is biased against face 23 to form a seal for mold 21 thereby enclosing space 24. When seated within mold 21, distal end 18 of fixture 13 is spaced from orifice 26 a sufficient distance to allow plastic material to be injected through orifice 26 and into the cavity surrounding cup 14 held within space 24.

Once cup 14 is ensconced within mold 21 and sealed, plastic material is injected through orifice 26 to fill the cavity surrounding cup 14 between the inner surface of mold 21 and external surface of cup 13. Due to the high temperature of the plastic material, it flows around cup 14 and surrounds the entire outer surface and lower end 18 up to and against flange 16. Because flange 16 is positioned in sealed relation with face 23, the plastic material does not flow beyond flange 16.

Any type of thermo-formable plastic is suitable for the herein described process, but thermoplastics with semi-crystalline polymer, such as those that are a type of polyester are best. One such type of thermo-formable plastic that is preferred is polybutylene terephthalate also known in the industry by the acronym “PBT.” PBT has less shrinkage that other thermo-formable plastics and has a higher impact resistance. Moreover, PBT is highly susceptible to impregnation of sublimated dyes through common high temperature sublimation processes using temperatures of between 170 degrees Celsius and 240 degrees Celsius, depending upon the amount of pressure utilized to press the image into the PBT surface during the dye sublimation process. However, PBT is partially translucent and does not facilitate the visual promotion of a dye sublimated image on a PBT surface. Hence, a formulation of 0.5% by weight of titanium oxide pigment may be added to produce a white background within the PBT prior to the sublimation of the dye image. Further, a greater weight and bulk may be achieved in the PBT material by adding barium sulfate. For example, a PBT formulation of 10% to 30% barium sulfate by weight can produce a heavier PBT exterior on container 14. A heavier exterior is preferred to produce a quality product and increases attractiveness to a potential consumer.

When PBT material is injected around cup 14, it has a temperature of approximately 260-270 degrees Celsius allowing it to flow easily through orifice 26 and into mold 21. PBT material is injected into mold 21 only enough to cover the exterior of container 14 and into any exterior features on its exterior, as will be discussed. Once plastic material flow ceases, cup and its surrounding PBT material rests until PBT material has cooled by approximately 40°. After such cooling time, which is typically about 1 to 2 minutes, the PBT material shrinks a small amount such that it surrounds and firmly adheres to the exterior surface of cup 14 and also detaches from the interior walls of mold 21. Such resulting shrinkage causes tension to surround cup 14 thereby increasing adhesion of the PBT material onto the outer surface of cup 14. After such cooling time, section 11 is withdrawn from section 12, and fixture 13 in combination with surrounding cup 14 is withdrawn from mold 21 beyond face 23. A worker operating machine 10 then reaches into the space between sections 11 and 12 and extracts cup 14 from fixture 13. Cup 14 now has an outer surface of PBT material of approximately 1 to 2 m millimeters in thickness. Effectively, cup 14 now has a relatively thick outer casing or sleeve of PBT material covering the entire exterior up to and bearing against circumferential flange 16.

As may be known, mold 21 may include surface features on its inner surface that may affect the outer exterior surface of the PBT material adhering to the exterior of cup 14. For example, a design of a particular pattern such as a grouping pattern or a mottled design pattern may be embossed into the exterior of the PBT material on the exterior of cup 14. Similarly, varying the degree of polish on surface of inside of the mold 21 will result in producing an exterior surface finish of the PBT material surrounding 14 of a gloss finish, a satin finish, or a rough, leathery finish.

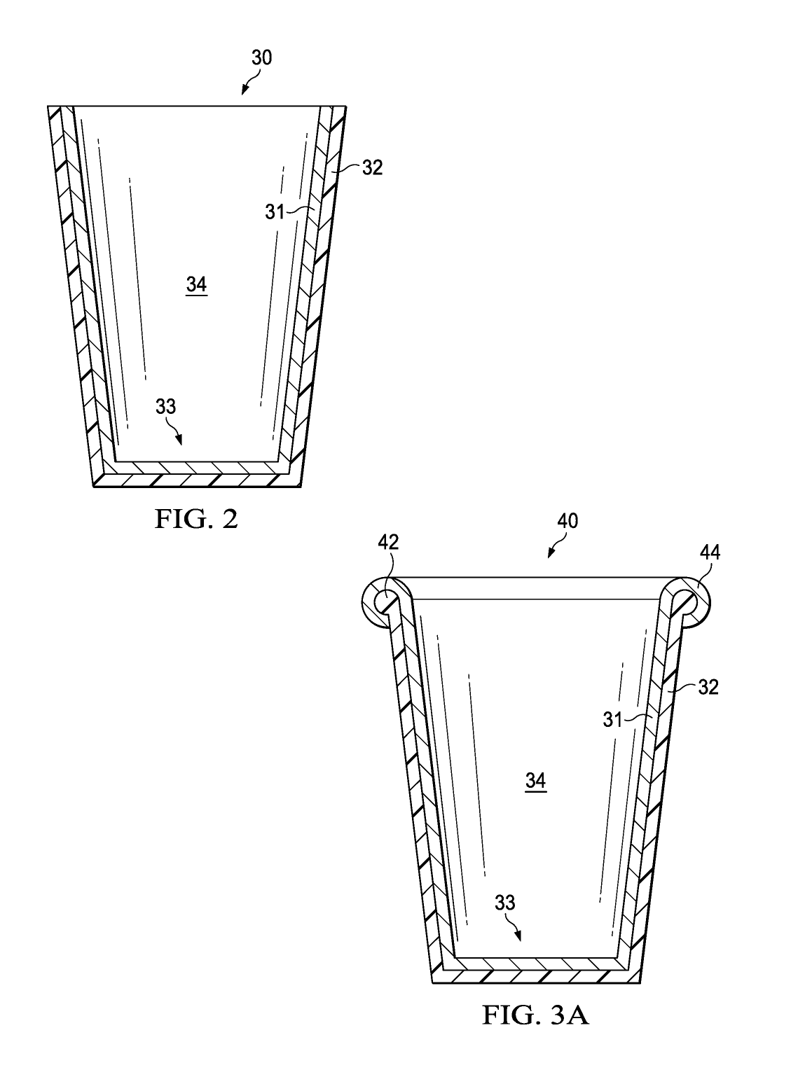

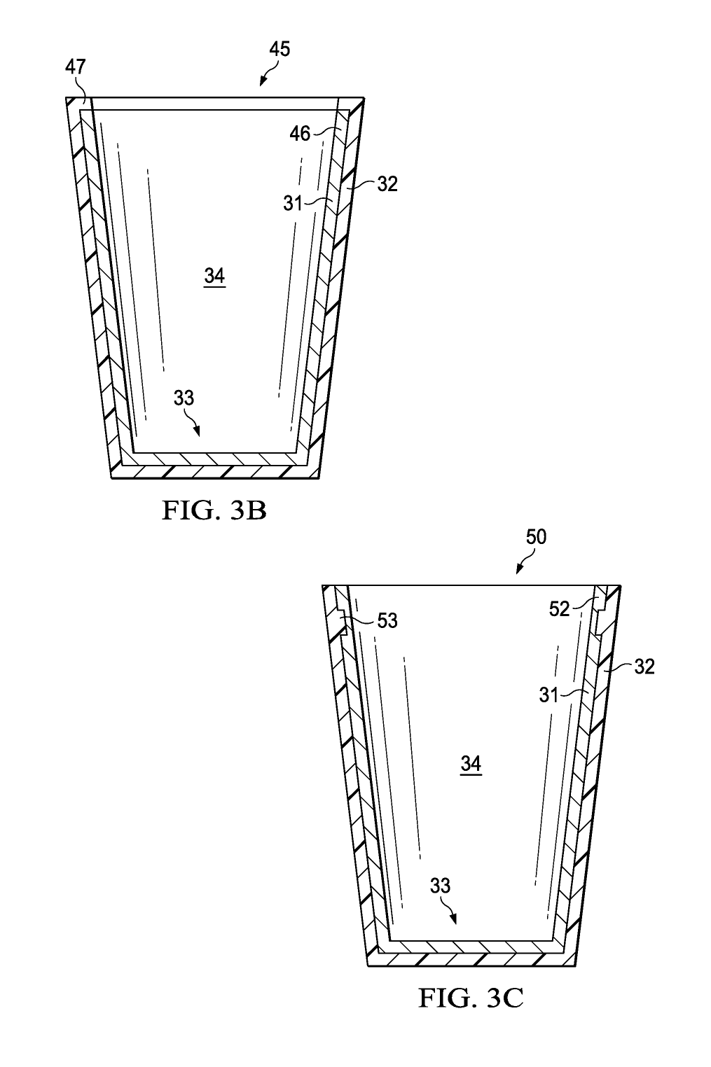

Referring now to FIGS. 2 and 3, different cup configurations having different physical features on their exteriors may be seen that facilitate the retention of a PBT sleeve surrounding cup 14 after extrusion. FIG. 2 shows a configuration 30 which is inferior to the embodiments shown in FIGS. 3A-3C. A cup configuration 30 has a steel cup body 31 with an interior 34 and a lower surface 33. Cup 31 has an exterior sleeve of PBT material 32 deposited onto its exterior surface. However configuration 30 can periodically suffer from sleeve 32 sliding down or slipping off the exterior of cup 31 under certain conditions, such as during handling over time or resulting from numerous temperature cycles. After sleeve of PBT material is affixed to the exterior of cup 31 during the injection process, shrinkage of approximately 5% occurs after the PBT material has cooled to room temperature. Because cup 31 is inflexible, cooling of the exterior PBT material causes tension to surround cup 31. Because cup 31 has a substantially trapezoidal shape, tension surrounding its exterior surface can cause sleeve 32 to move downward and away from the exterior surface of cup 31. This movement tends to relieve tension on the lower portions of the sleeve 32 as it slips off partially cup 31 until such tension is subsided appreciably. Hence, a continual biasing of the sleeve toward the lower portion of cup 31 exists. Further, use and handling of configuration 30 can hasten movement of sleeve 32 downward and away from cup exterior 31 over time.

Referring now to FIG. 3A, a superior configuration is shown in which sleeve movement downward over cup 31 is prohibited. Configuration 40 shows cup 31 having been exterior circumferential flange 44 at its uppermost circumferential surface. When cup 31 and configuration 40 is placed within injection molding machine 10, PBT material is injected that surrounds cup 31, but due to the obstructing presence of flange 44 PBT material enters cavity 42 forming a circumferential bead encapsulated within flange 44. As PBT material on sleeve 32 cools, the PBT material shrinks but is uniformly stretched over the exterior surface of cup 31, thereby holding the exterior sleeve of PBT material within the cavity and stopping slippage downward during cooling. Further, as exterior sleeve of PBT material 32 cools to room or ambient temperature, tension is distributed within and along the inner surface of flange 44 to better support the exterior sleeve around cup 31. This results in a highly distributed tension circumferentially retained by the upper surface flange 44 and surrounding the exterior surface of cup 31. In this configuration 40, sleeve 32 cannot slip downward irrespective of the trapezoidal shape that cup 31 may have.

Referring now to FIG. 3B, it may be seen that cup 31 is sized such that when placed within mold 21 of section 12 PBT material flows along and around upper surface 46 of cup 31 to form a circumferential ring of material 47 positioned adjacent to the interior 34 of the cup and covering its entire upper surface 46. Configuration 45 is only possible when fixture 13 includes its own circumferential flange adjacent to surface 17 thereby sealing fixture 13 against mold 21 when sections 11 and 12 are drawn together during extrusion. However configuration 45 facilitates the fixing of PBT sleeve 32 around cup 31 because circumferential ring 47 shrinks inwardly toward interior 34 of cup 31 thereby distributing tension of sleeve 32 over and into cup the interior surface of cup 31 such that material near upper service 46 cannot slip downward toward lower portion 33. Configuration 45 also allows for a less expensive and more easily manufactured cup 31 and allows for a superior appearance configuration than the configuration 40 shown in FIG. 3A.

Configuration 50 shown in FIG. 3C provides a further embodiment that allows for the distributing of tension of sleeve 32 as it cools around cup 31. In particular, cup 31 includes a circumferential flange below upper surface 52. As PBT material is encapsulated around the outer surface of cup 31 within mold 21, group 53 promotes the formation of a circumferential ring of PBT material surrounding the upper portion of cup 31 along its exterior that locks sleeve 32 around the outer surface of 31 toward its upper edge as it cools to ambient temperature. Hence, while a small amount of PBT material may slip downward above the flange or groove 53, material at or below groove 53 will not move downward toward lower and 33 as it cools or due to handling. Hence, sleeve 32 is locked surrounding cup 31 and does not slip or move off of the exterior surface of cup 31 due to handling or shrinkage.

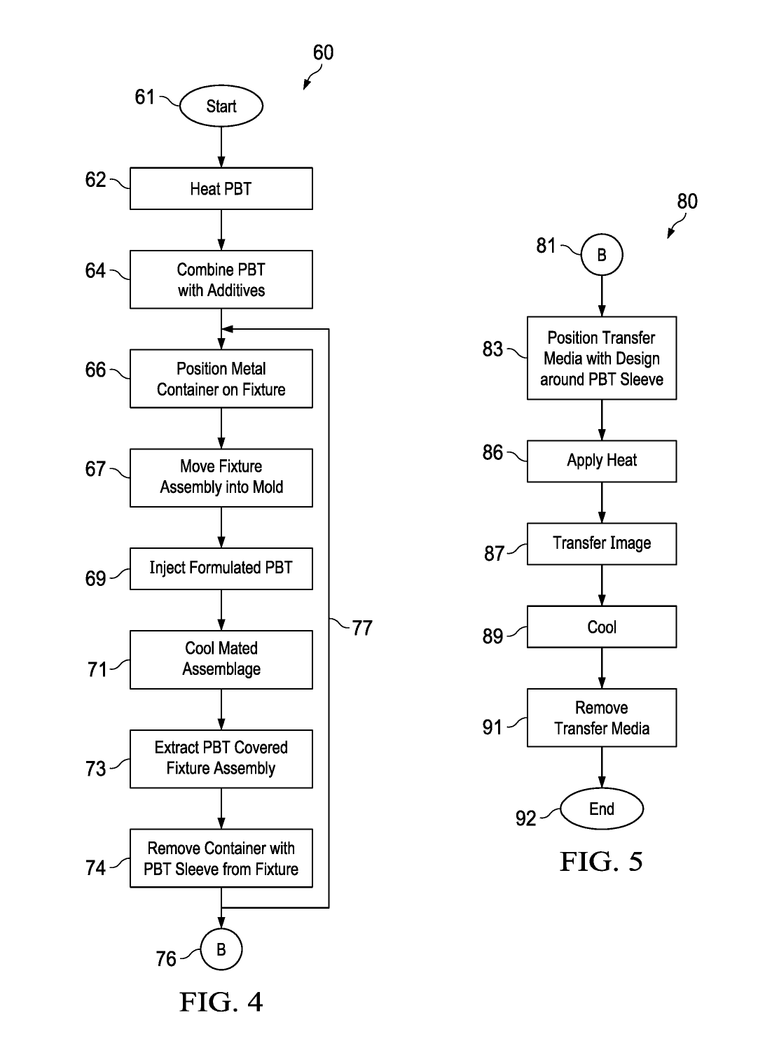

Referring now to FIG. 4, it may be seen a process by which PBT material may be utilized to create a sleeve surrounding a metal container, such as a drinking cup. Initially, PBT material is heated to approximately 115 degrees Celsius for about 4 hours, and combined with additives 64, such as titanium oxide or borate. Some injection molding machines are configured to mix additives with molten plastic prior to an injection step, but alternatively PBT material may be separately combined with additives and formed into PBT pellets that may be heated just prior to injection molding with the additives premixed within the material. This obviates the necessity of mixing within or adjacent to the injection molding machine during the injection molding process.

Fixture 13 is also heated to approximately 60 degrees Celsius for at least 1 hour and, after fixture heating, a metal container, such as a drinking cup, is positioned 66 over the fixture 13 within the machine 10. Various types of metal stock container may be utilized for process 60, but for drinking cups stainless steel or stainless aluminum is preferred. Further, ceramic may be also utilized as long as the ceramic material will not crack at the temperatures to which the container will be exposed within mold 21. Typically, metal containers such as steel coffee cups or stainless steel travel mugs are placed adjacent to injection molding machines 10 and a worker places each container onto the injection molding machine fixture 13 from a stockpile of metal containers ready to be inserted. Once a container is placed over fixture 66 the cup and fixture assembly is inserted into a mold and heated 67 so that PBT material may more easily flow and surround the exterior surface of the metal container. The PBT formulated material is then injected 69 to surround container and fill all grooves or cavities that container may have. The mated assemblage of fixture container and mold is then held in place until the assemblage cools sufficiently 71 such that the PBT material shrinks and dislocates from the interior surface of the mold 21. Typically, this will only take 1 to 2 minutes for this cooling process to occur. A worker then moves the fixture and the PBT covered metal container away from the mold thereby extracting the combination from the mold entirely 73. The steel container having a new exterior sleeve of PBT is then removed from the fixture 74 and readied for shipment. The operation is configured with sufficient raw materials such that the PBT sleeve process may be continually repeated 77 to form an efficient manufacturing process. Once a desired number of PBT sleeves are extruded onto the exterior of metal containers, those containers may be moved to a sublimation transfer process B 76 as further shown in FIG. 5.

A dye-sublimation process to add an image or design to the exterior of a PBT cup may be part of a single manufacturing operation in which processes 60 and 80 are a single continuous process, or cups produced in accordance with process 60 may be shipped to a different manufacturing facility geographically remote from the site of process 60 for further processing pursuant to process 80. As shown in FIG. 5, an encapsulated container from B 81 is positioned 83 such that a transfer media with a desired design may be wrapped around a PBT sleeve. As is known, transfer media for sublimation applications are designed to be impregnated with inks optimized for a sublimation transfer from the transfer media onto the exterior of an object, such as a coffee mug or drinking cup. Typically, the transfer media with a design is positioned to surround the exterior surface of the PBT material sleeve and affixed with tape or other mechanism like silicon glue for maintaining its position on the exterior surface of the cup. The combination of the transfer paper with design and the cup is then heated 86 to approximately 250° C. for approximately 4 to 5 minutes, depending upon the type of sublimation system utilized. Some systems press an image against the exterior of an object, thereby reducing the heat to be applied to around 160 degrees Celsius, or oven based systems utilize higher temperatures of around 450 degrees Celsius. This heating process causes the image on the transfer media to be transferred 87 from the transfer media material to be impregnated within the surface of the PBT material surrounding the cup. Once the transfer is complete, the cup is cooled 89 and the transfer media is removed 91, leaving the sublimated image or design diffused into the plastic material surrounding the cup.

While I have shown my invention in one form, it will be obvious to those skilled in the art that it is not so limited but is susceptible of various changes and modifications without departing from the spirit thereof.

Having set forth the nature of the invention, what is claimed is:

1. A process for covering a container with plastic, comprising the steps of:
a. placing a container over a fixture in a plastic extrusion machine;
b. inserting the container and fixture combination into a mold in sealed relation, wherein said container is spaced from the interior surface of said mold thereby creating a gap separating the two;
c. injecting plastic into said mold and filling said gap;
d. letting said plastic cool;
e. separating said fixture and container combination from said mold; and,
f. removing said covered container from said fixture.

2. The process as recited in claim 1, further including the step of forming a circumferential flange on the upper surface of said container, wherein said flange defines a cavity having an opening along the exterior of said container, and wherein said opening is smaller than the maximum distance said cavity extends away from the exterior surface of said container such that upon the cooling of said plastic held within said cavity said cooled plastic cannot withdraw from said cavity.

3. The process as recited in claim 1, further including the step of forming a circumferential groove adjacent to the upper edge of said container, wherein said groove is shaped to receive a flow of heated plastic such that upon the cooling of said plastic held within said groove said cooled plastic cannot withdraw from said groove.

4. The process as recited in claim 1, wherein said step of extruding plastic over said metal container held by said fixture includes extruding said plastic over and entirely covering the upper edge of said container such that upon the cooling of said plastic surrounding said container said plastic covering said upper edge cannot withdraw from said upper surface.

5. The process as recited in claim 1, further including the step of forming a circumferential flange on the upper surface of said container, wherein said flange defines a cavity such that a bead of solid plastic forms within said cavity upon the cooling of said plastic held within said cavity, whereby said exterior of cooled plastic cannot slip down the exterior of said container after cooling.

6. The process as recited in claim 2, 3, 4, or 5, wherein said step of extruding plastic over a metal container comprises extruding polybutylene terephthalate.

7. The process as recited in claim 6, wherein said injection step results in a plastic exterior surrounding said container having a thickness of between 0.8 mm and 2.0 mm.

8. The process as recited in claim 7, wherein said injection step results in a plastic exterior surrounding said container having a thickness of approximately 1.3 mm.

9. The process as recited in claim 7, wherein said container includes materials selected from the group consisting of stainless steel, aluminum, ceramics, or an aluminum alloy.

10. The process as recited in claim 7, wherein said polybutylene terephthalate is mixed with 0.5% titanium pigment by weight and 10% barium sulfate by weight prior to said injection step.

11. A process for covering a container with plastic, comprising the steps of:
a. extruding plastic over a metal container held by a fixture over
b. the entire exterior of said container;
c. allowing said plastic to cool and harden; and,
d. transferring an image onto the plastic exterior of said container through dye sublimation.

12. The process as recited in claim 11, wherein said extrusion step utilizes polybutylene terephthalate plastic mixed with 0.5% titanium oxide pigment by weight and 10% barium sulfate by weight.

13. The process as recited in claim 11, wherein said extrusion step utilizes polybutylene terephthalate plastic mixed with between 10% and 30% barium sulfate by weight.

14. The process as recited in claim 11, wherein said extrusion step utilizes polybutylene terephthalate plastic mixed with titanium oxide pigment to provide a better white background for promoting said image.

15. The process as recited in claim 12, 13, or 14, wherein said extrusion step utilizes a mold having surface features and which produces a textured finish on the exterior of said plastic after cooling selected from the group consisting of a gloss finish, a satin finish, or a rough finish.

16. The process as recited in claim 15, wherein said step of extruding plastic over a metal container comprises the steps of;
a. heating said polybutylene terephthalate to approximately 115 degrees Celsius for 4 hours prior to said extrusion step;
b. heating said fixture to 60 degrees Celsius for at least 1 hour prior to said extrusion step; and,
c. wherein said plastic is extruded at a temperature of between 260 degrees and 270 degrees Celsius.

17. The process as recited in claim 16, wherein said extrusion step results in a plastic exterior surrounding said container having a thickness of between 0.8 mm and 2.0 mm.

18. The process as recited in claim 16, further including the step of forming a circumferential flange on the upper surface of said container, wherein said flange defines a cavity such that a bead of solid plastic forms within said cavity upon the cooling of said plastic held within said cavity, whereby said exterior of cooled plastic cannot slip down the exterior of said container after said cooling step.

19. A container adapted for receiving a dye sublimatable image on its exterior, comprising:
a. a container having an exterior and an upper circumferential edge;
b. an extruded layer of polybutylene terephthalate deposited on said exterior and having a thickness of at least 0.8 mm; and,
c. a surface feature formed on the exterior of said container adjacent to said upper edge, wherein said surface feature is filled with hardened polybutylene terephthalate such that said exterior plastic exterior is prevented from slipping down said container exterior.

20. The container as recited in claim 19, further including a dye sublimated image impregnated onto the exterior surface of said polybutylene terephthalate covering.

21. The container as recited in claim 20, further comprising a circumferential flange formed on the upper surface of said container, wherein said flange defines a cavity having an opening along the exterior of said container, and wherein said opening is smaller than the maximum distance said cavity extends away from the exterior surface of said container such that upon the cooling and hardening of said polybutylene terephthalate after extruding said plastic over said container the polybutylene terephthalate is held within said cavity and said entire plastic covering is held in place by polybutylene terephthalate held in said cavity.

22. The container as recited in claim 20, wherein said polybutylene terephthalate is mixed with 0.5% titanium oxide pigment by weight and 10% barium sulfate by weight.
